(19) United States
(12) Patent Application Publication
(10) Pub. No.: US 2019/0214776 A1
(43) Pub. Date: Jul. 11, 2019

(54) CONNECTOR

(71) Applicant: Sumitomo Wiring Systems, Ltd., Yokkaichi, Mie (JP)

(72) Inventors: Kenya Takahashi, Yokkaichi, Mie (JP); Daisuke Ito, Yokkaichi, Mie (JP)

(21) Appl. No.: 16/099,202

(22) PCT Filed: May 2, 2017
(86) PCT No.: PCT/JP2017/017215

§ 371 Date: Nov. 6, 2018

(30) Foreign Application Priority Data
May 23, 2016 (JP) 2016-102245

(51) Int. Cl. H01R 13/74; H01R 13/50; B60L 53/16

(52) U.S. Cl. CPC H01R 13/74; H01R 2201/26; B60L 53/16; H01R 13/50

(57) ABSTRACT

A connector 10 disclosed by this specification includes a connector fitting portion 21 having a receptacle 23 open forward, a mounting portion (mounting plate 24) coupled to a peripheral surface of the receptacle 23 and provided with collar mounting holes 26 penetrating in a front-rear direction on an outer peripheral side of the receptacle 23, and collars 30 press-fit into the collar mounting holes 26 from behind. Receiving portions 27 projecting forward from a front surface of the mounting portion are provided at positions on sides opposite to the connector fitting portion 21 out of opening edge parts of the collar mounting holes 26 on the front surface of the mounting portion.

### BACKGROUND

### Field of the Invention

This specification relates to a connector.

### Related Art

Japanese Unexamined Patent Publication No. 2012-221613 discloses a vehicle-side connector to be fixed to a vehicle. The vehicle-side connector includes a connector housing made of synthetic resin. The connector housing includes a mounting piece in the form of a substantially rectangular flat plate and a hollow cylindrical receptacle integral to the mounting piece. Collar mounting holes are provided at four corners of the mounting piece, and collars are press-fit into these collar mounting holes from the outside of the vehicle. The connector housing is fixed to the vehicle by attaching rear end parts of the collars to the vehicle from the outside of the vehicle and inserting fixing bolts through the collars from the outside of the vehicle and tightening the fixing bolts into the vehicle.

In the above-described vehicle-side connector, the collar is press-fit into the collar mounting hole by arranging a receiving tool on a back surface side of the mounting piece and pressing the collar from a front surface. Thus, even if the back surface of the mounting piece is scratched by the receiving tool, the front surface side of the mounting piece is not scratched. Accordingly, with the vehicle-side connector fixed to the vehicle, scratches on the back surfac of the mounting piece are unseen from the outside of the vehicle and are not problematic in appearance. However, if the vehicle-side connector is fixed to the vehicle from the inside of the vehicle, the receiving tool has to be arranged on the front surface of the mounting piece to press-fit the collar into the collar mounting hole. If a part contacted by the receiving tool is at a position seen from the outside of the vehicle, scratches may be formed at the position seen from the outside of the vehicle.

### SUMMARY

A connector disclosed by this specification includes a connector fitting portion having a receptacle open forward. A mounting portion is coupled to a peripheral surface of the receptacle and is provided with a collar mounting hole penetrating in a front-rear direction on an outer peripheral side of the receptacle. A collar is press-fit into the collar mounting hole from behind. A receiving portion projects forward from a front surface of the mounting portion at a position on a side opposite to the connector fitting out of an opening edge part of the collar mounting hole on the front surface of the mounting portion.

According to this configuration, in press-fitting the collar into the collar mounting hole, the receiving portion is attached to a receiving tool and the collar is press-fit into the collar mounting hole from a rear surface side of the mounting portion. At this time, even if the receiving portion is scratched by the receiving tool, scratches on the receiving portion are unseen from the outside of a vehicle since the scratches on the receiving portion are hidden by a body of the vehicle if the mounting portion is attached to the body of the vehicle from the inside of the vehicle and a fixing bolt is inserted through the collar from the inside of the vehicle and tightened into the body of the vehicle. As just described, the receiving portion is at the position unseen from the outside of the vehicle when the connector is fixed to the body of the vehicle. Thus, even if the receiving portion is scratched, it is not problematic in appearance.

The receiving portion may be provided between an outer peripheral edge of the mounting portion and the collar mounting hole. According to this configuration, the receiving portion can utilize a dead space between the outer peripheral edge of the mounting portion and the collar mounting hole.

The receiving portion may be at a position most distant from the connector fitting portion in a front view. According to this configuration, the connector fitting portion is not likely to be scratched because the receiving tool is not likely to contact the connector fitting portion by mistake.

According to the connector disclosed by this specification, even if the receiving portion is scratched by the receiving tool, scratches are unseen from the outside of the vehicle.

### BRIEF DESCRIPTION OF DRAWINGS

FIG. 1 is a front view of a connector.

FIG. 2 is a side view of the connector.

FIG. 3 is a plan view of the connector.

FIG. 4 is a perspective view of a collar.

FIG. 5 is a side view of the collar.

FIG. 6 is a front view of the collar.

FIG. 7 is a front view of a housing.

FIG. 8 is a section along A-A in FIG. 1 showing a state before the collar is press-fit into a collar mounting hole.

FIG. 9 is a section along A-A in FIG. 1 showing a state after the collar is press-fit into the collar mounting hole.

### DETAILED DESCRIPTION

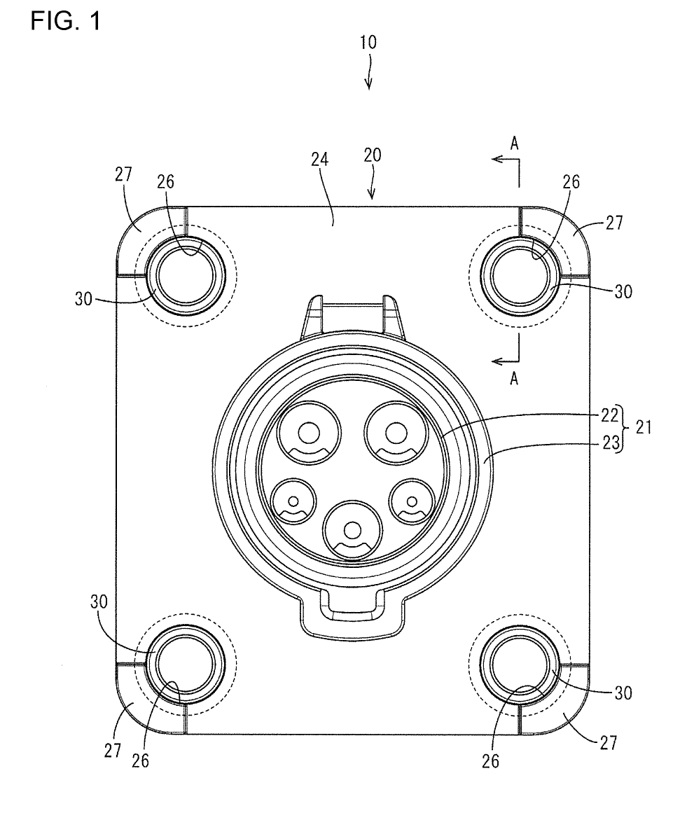

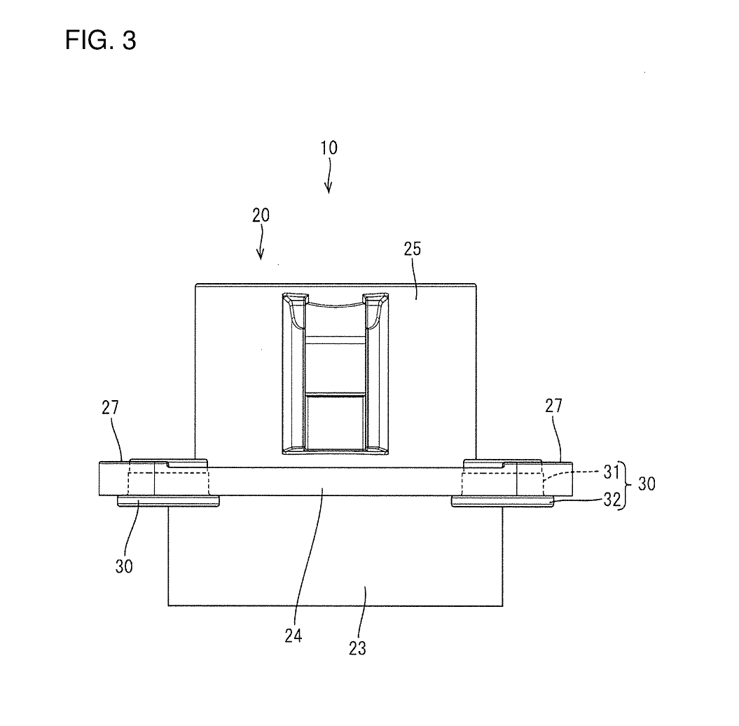

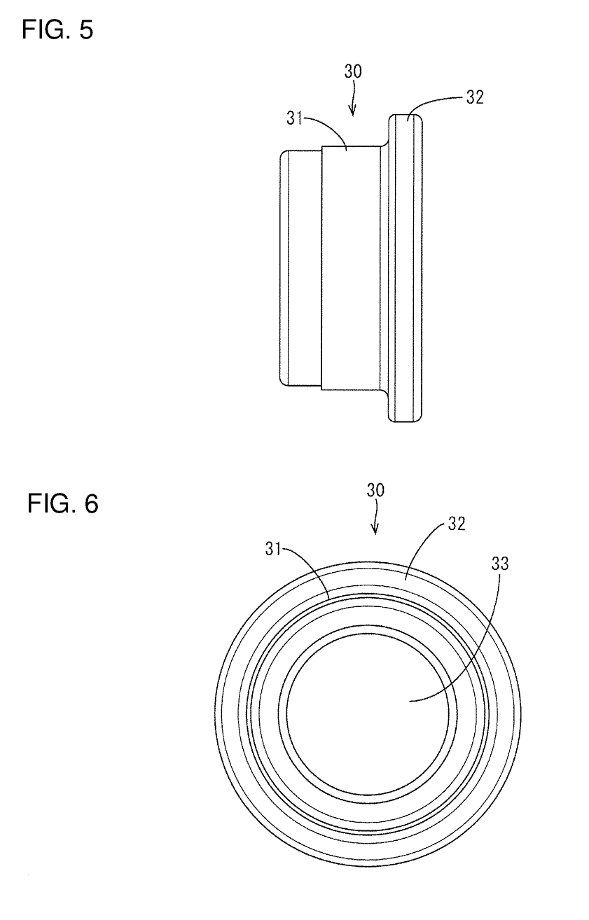

An embodiment is described with reference to FIGS. 1 to 9. A connector 10 of this embodiment includes, as shown in FIG. 1, a connector housing 20 made of synthetic resin and collars 30 integrally fixed to the housing 20. The housing 20 includes a connector fitting portion 21 fittable to an unillustrated mating connector. The connector fitting portion 21 includes a substantially cylindrical terminal accommodating portion 22 and a substantially hollow cylindrical receptacle 23 provided around the terminal accommodating portion 22. The receptacle 23 is open forward, and the terminal accommodating portion 22 and the receptacle 23 are arranged substantially coaxially.

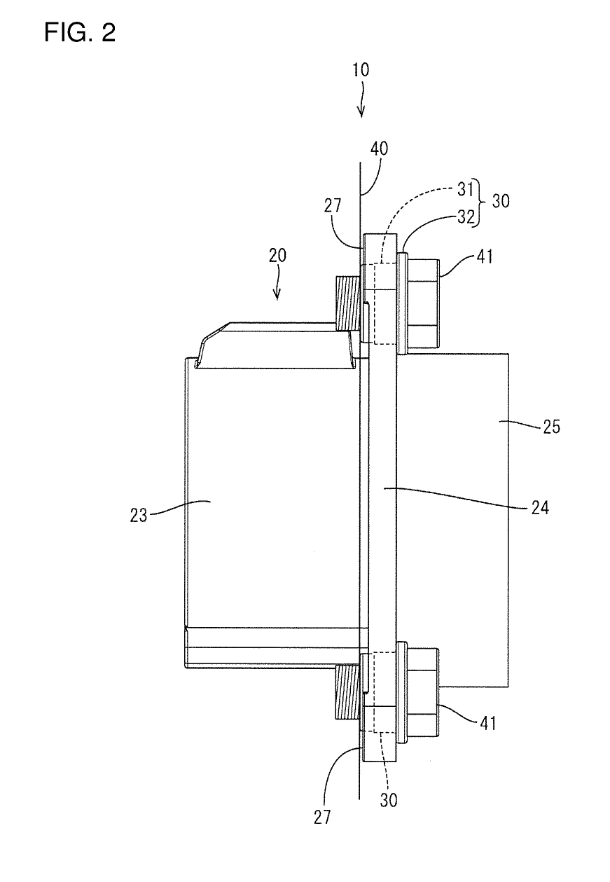

The housing 20 includes a mounting plate 24 having a square shape in a front view. The mounting plate 24 is a flat plate arranged to be perpendicular to an axis of the receptacle 23. Further, the mounting plate 24 is coupled to a rear end part of the receptacle 23. A part of the mounting plate 24 on an outer peripheral side of the receptacle 23 is composed of one plate and protrudes radially out from the outer peripheral surface of the receptacle 23. The terminal accommodating portion 22 penetrates through the mounting plate 24 in a front-rear direction, whereas the receptacle 23 projects forward from the front surface of the mounting plate 24. Note that, as shown in FIG. 2, a mounting tube 25 is provided behind the mounting plate 24, and an unillustrated retainer is to be mounted therein.

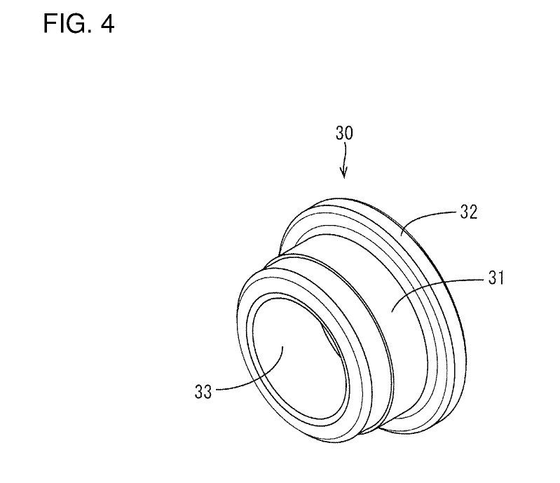

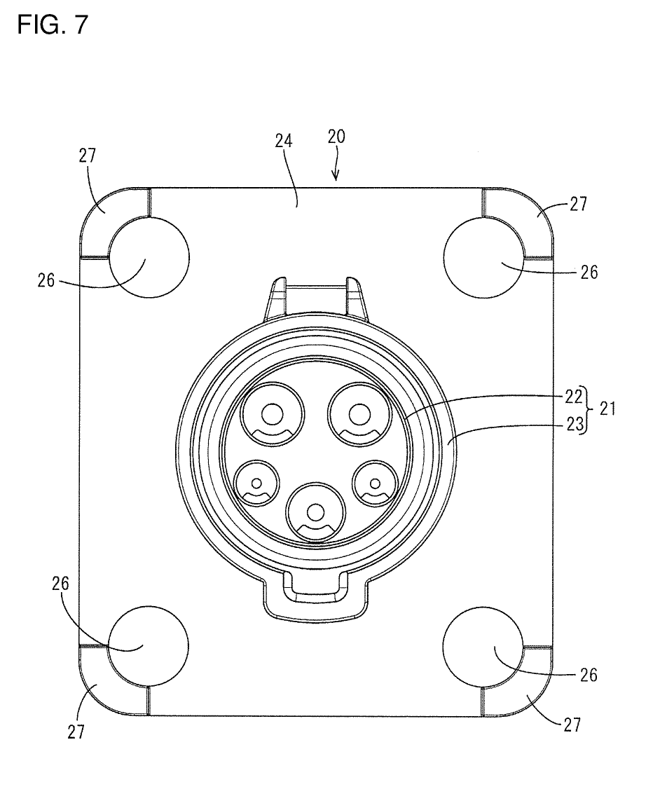

As shown in FIG. 7, collar mounting holes 26 are provided at four corner parts of the mounting plate 24 located on the outer peripheral side of the receptacle 23. The collar mounting holes 26 penetrate through the mounting plate 24 in the front-rear direction. Substantially hollow cylindrical collars 30 are mountable into the collar mounting holes by press-fitting. As shown in FIGS. 4 to 6, the collar 30 includes a hollow cylindrical shaft 31 and a flange 32 is provided on a rear end part of the shaft portion 31. Further, a bolt insertion hole 33 penetrates the shaft 31 in the front-rear direction.

As shown in FIG. 2, the flange 32 of the collar 30 is in contact with the rear surface of the mounting plate 24, the shaft 31 is disposed through the mounting plate 24, and a front end part of the shaft 31 projects slightly from the front surface of the mounting plate 24. The front part of the shaft 31 is attached to the rear surface of a body 40 of a vehicle from the inside of the vehicle. A fixing bolt 41 is inserted through the bolt insertion hole 33 from the inside of the vehicle and tightened into the body 40 to fix the connector 10 to the body 40. Specifically, an opening edge of the collar mounting hole 26 is in contact with the body 40 via the collar 30 and is disposed at a position hidden from the front by the body 40. Therefore, the opening edge part is unseen from the outside of the vehicle.

As shown in FIG. 7, receiving portions 27 are provided at positions on sides opposite to the connector fitting portion 21 outward of the opening edges of the collar mounting holes 26. Each receiving portion 27 is in the form of a rib projecting forward from the front surface of the mounting plate 24. As shown in FIG. 2, the front surface of the receiving portion 27 is flat and is located behind the front of the shaft 31 of the collar 30 so as not to interfere with the body 40. As shown in FIG. 7, the receiving portion 27 is disposed between the outer peripheral edge of the mounting plate 24 and the peripheral edge of the collar mounting hole 26. Further, the receiving portion 27 is arcuate at a position most distant from the connector fitting portion 21 in a front view.

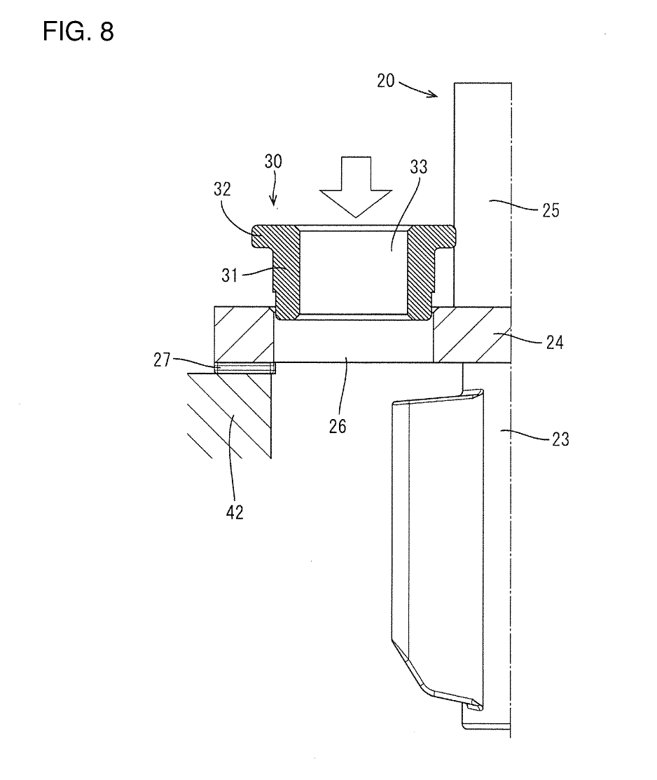

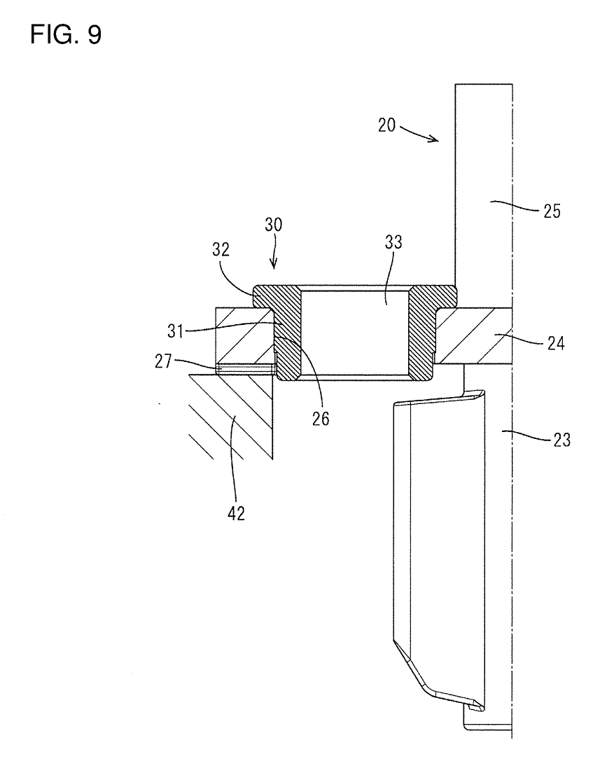

The front surface of the receiving portion 27 serves as a contact surface when the collar 30 is press-fit into the collar mounting hole 26 from behind (rear surface side of the mounting plate 24). In the following description, an upper side shown in FIG. 8 is referred to as a rear side. To press-fit the collar 30 into the collar mounting hole 26, the receiving portion 27 is placed on a receiving tool 42. Subsequently, the collar 30 is pushed in a direction of a shown arrow so that the shaft 31 of the collar 30 is inserted into the collar mounting hole 26. Pushing of the collar 30 is stopped when the flange 32 of the collar 30 contacts the rear surface of the mounting plate 24 as shown in FIG. 9. In this way, the press-fitting of the collar 30 is completed.

In press-fitting the collar 30, the receiving portion 27 may be scratched by the receiving portion 42. However, the receiving portion 27 is at the position hidden by the body 40 of the vehicle and unseen from the outside of the vehicle. Thus, even if the receiving portion 27 is scratched, it is not problematic in appearance. Further, if a force is applied in a vertical or lateral direction with the unillustrated mating connector fit to the connector fitting portion 21, the receiving portions 27 contact the collars 30 from outside. Thus, a relative arrangement of the housing 20 with respect to the collars 30 is maintained and a positional deviation of the connector 10 can be prevented.

As described above, the connector 10 disclosed by this embodiment includes the connector fitting portion 21 having the receptacle 23 open forward. A mounting portion (mounting plate 24) is coupled to the peripheral surface of the receptacle 23 and is provided with the collar mounting holes 26 penetrating in the front-rear direction on the outer peripheral side of the receptacle 23. The collars 30 are press-fit into the collar mounting holes 26 from behind, and the receiving portions 27 project forward from the front surface of the mounting portion at the positions on the sides opposite to the connector fitting portion 21 outward of the opening edge parts of the collar mounting holes 26 on the front surface of the mounting portion.

According to this configuration, in press-fitting the collar 30 into the collar mounting hole 26, the receiving portion 27 is attached to the receiving tool 42 and the collar 30 is press-fit into the collar mounting hole 26 from the rear surface of the mounting portion. At this time, even if the receiving portion 27 is scratched by the receiving tool 42, scratches on the receiving portion 27 are unseen from the outside of the vehicle, since the scratches on the receiving portion 27 are hidden by the body 40 if the mounting portion is attached to the body 40 from the inside of the vehicle and the fixing bolt 41 is inserted through the collar 30 from the inside of the vehicle and tightened into the body 40 of the vehicle. As just described, since the receiving portions 27 are provided at positions unseen from the outside of the vehicle when the connector 10 is fixed to the body 40 of the vehicle. Thus, scratches on the receiving portions 27 are not problematic in appearance.

The receiving portions 27 may be provided between the outer peripheral edge of the mounting portion and the collar mounting holes 26. According to this configuration, the receiving portions 27 utilize dead space between the outer peripheral edge of the mounting portion and the collar mounting holes 26.

The receiving portions 27 may be provided at positions most distant from the connector fitting portion 21 in a front view. According to this configuration, the receiving portions 27 are provided at the positions most distant from the connector fitting portion 21. Thus, the connector fitting portion 21 is not likely to be scratched by inadvertent contact of the receiving tool 42 with the connector fitting portion 21.

The invention is not limited to the above described and illustrated embodiment. For example, the following modes are also included.

Although the receptacle 23 has a hollow cylindrical shape in the above embodiment, a receptacle having a polygonal shape may be used.

Although one mounting plate 24 in the form of a flat plate is illustrated as the mounting portion in the above embodiment, a plurality of mounting pieces protruding radially outward from the outer peripheral surface of the receptacle 23 may constitute the mounting portion.

Although the rib-like receiving portion 27 is illustrated in the above embodiment, a receiving portion composed of a plurality of protrusions may be used.

Although the receiving portion 27 is provided at the position most distant from the connector fitting portion 21 in the above embodiment, the receiving portion only has to be located at a position unseen from the outside of the vehicle and may not be at the position most distant from the connector fitting portion 21.

### LIST OF REFERENCE SIGNS

10 . . . connector
21 . . . connector fitting portion
23 . . . receptacle
24 . . . mounting plate (mounting portion)
26 . . . collar mounting hole
27 . . . receiving portion
30 . . . collar

1. A connector, comprising:
a connector fitting portion including a receptacle open forward;
a mounting portion coupled to a peripheral surface of the receptacle and provided with a collar mounting hole penetrating in a front-rear direction on an outer peripheral side of the receptacle; and
a collar press-fit into the collar mounting hole from behind;
a receiving portion projecting forward from a front surface of the mounting portion being provided at a position on a side opposite to the connector fitting portion out of an opening edge part of the collar mounting hole on the front surface of the mounting portion.

2. The connector of claim 1, wherein the receiving portion is provided between an outer peripheral edge of the mounting portion and the collar mounting hole.

3. The connector of claim 2, wherein the receiving portion is provided at a position most distant from the connector fitting portion in a front view.

4. The connector of claim 1, wherein the receiving portion is provided at a position most distant from the connector fitting portion in a front view.
